(19) United States
(12) Patent Application Publication
(10) Pub. No.: US 2008/0172651 A1
(43) Pub. Date: Jul. 17, 2008

(54) Applying Function Level Ownership to Test Metrics

(75) Inventor: Brian D. Davia, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/623,169

(22) Filed: Jan. 15, 2007

(51) Int. Cl. G06F 9/44

(52) U.S. Cl. 717/124

(57) ABSTRACT

Function level ownership may be applied. First, in response to running a plurality of different test cases, metrics correspond to a plurality of traces may be received. Each of the plurality of traces may respectively correspond to a plurality of outputs respectively produced by running each of the plurality of different test cases. Next, ownership data may be received. The ownership data may indicate a testing entity responsible for losing at least one function corresponding to a software program that was tested as a result of running the plurality of different test cases, in addition, the ownership data may indicate a developing entity responsible for developing at least one function corresponding to the software. Then, the ownership data may be applied to the metrics corresponding to the plurality of traces.

### RELATED APPLICATIONS

Related U.S. patent application Ser. No. ______, entitled “Saving Code Coverage Data for Analysis,” Ser. No. ______, entitled “Collecting and Reporting Code Coverage Date,” and Ser. No. ______, entitled “Identifying Redundant Test Cases,” assigned to the assignee of the present application, and filed on even date herewith, are hereby incorporated by reference.

### BACKGROUND

When developing software, programming modules may be tested during the development process. Such testing may produce, for example, code coverage data. Coda coverage data may comprise metrics that may indicate what code pieces within a tested programming module have been executed during the programming module's test. The cede coverage data may be useful in a number of ways, for example, for prioritizing testing efforts.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Function level ownership may be applied. First in response to running a plurality of different test cases, a plurality of traces may be received. Each of the plurality of traces may respectively correspond to a plurality of outputs respectively produced by running each of the plurality of different test cases. Next, ownership data may be received. The ownership data may indicate a testing entity responsible for tasting at least one function corresponding to a software program that was tested as a result of running the plurality of different test cases. In addition, the ownership data may indicate a developing entity responsible for developing at least one function corresponding to the software. Then, the ownership data may he applied to metrics resulting from the plurality of traces.

Both the foregoing general description and die following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described In the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for applying function level ownership to metrics traces; and

FIG. 3 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

A software testing tool may fee used by a computer program tester to collect code coverage data. The code coverage data may allow the tester to see which code pieces (e.g. code lines) are executed while testing a software program. The testers may use the software testing tool to collect code coverage data during an automation run (e.g. executing a plurality of test cases) to see, for example, which code lines in the software program were executed by which test cases during the automation run.

A test case may be configured to test aspects of the software program. To do so, the test case may operate on a binary executable version of the software program populated with coverage code with extra instructions (instrumented) for collecting code coverage data. For example, the test case may be configured to cause the binary executable version to open a file. Consequently, the coverage code in the binary executable version may be configured to produce the code coverage data configured to indicate what code within the binary executable version was used during the test. In this test example, the coverage code may produce the code coverage data indicating what code within the binary executable version was executed during the lie opening test. A trace may comprise a unit of code coverage data collected from a test case run. A trace may comprise code blocks executed from the beginning to the end of the test case.

The tested software program may comprise, for example, a large number of functions. The software program may also have a large number of testers and developers working to develop, improve, and verify the software program. Metrics from code coverage data may be used to determine the software program's state in relation, for example, to a shipping goal. These metrics may also help in making business decisions, such as whether or not to slip a ship date or push through toward an original ship date.

As stated above, code coverage may allow developers to see which software program pieces have been executed during testing. Based on code coverage data, developers can decide whether or not test efforts on the software program have been sufficient in covering a good breadth. When developers took at code coverage data at a more granular level, such as the code coverage for each function in the software program, developers can identify individual areas for the software program that need additional testing. However, in large software systems, it may be difficult to know where to start and who is responsible for the software program functions that may need the developer's attention.

Consistent with embodiments of the invention, accountability may be assigned to individuals responsible for testing code functions and to individuals responsible for developing code functions. For example, as testers and developers claim responsibility for code portions (e.g. functions), ownership may be applied to various data sources and reports may be generated based on the code owned by testers and/or developers. Moreover, testers and developers may be mapped to teams generating reports at, for example, a team level. As a result, ownership may be applied to the code. A trace may represent which pieces of code were executed by a particular test. This code execution may range across many pieces of the software program. These pieces may be owned by many different testers/developers. Consequently, ownership may be assigned to the code that the trace touch. As stated above, a trace, in the context of code coverage, may be a representation of code blocks touched (and untouched) during the execution of a test case. A metric may be defined as a rule for quantifying some characteristic or attribute of the software program. Consistent with embodiments of the invention, code coverage may foe an example of one of many metrics for which ownership data may foe applied.

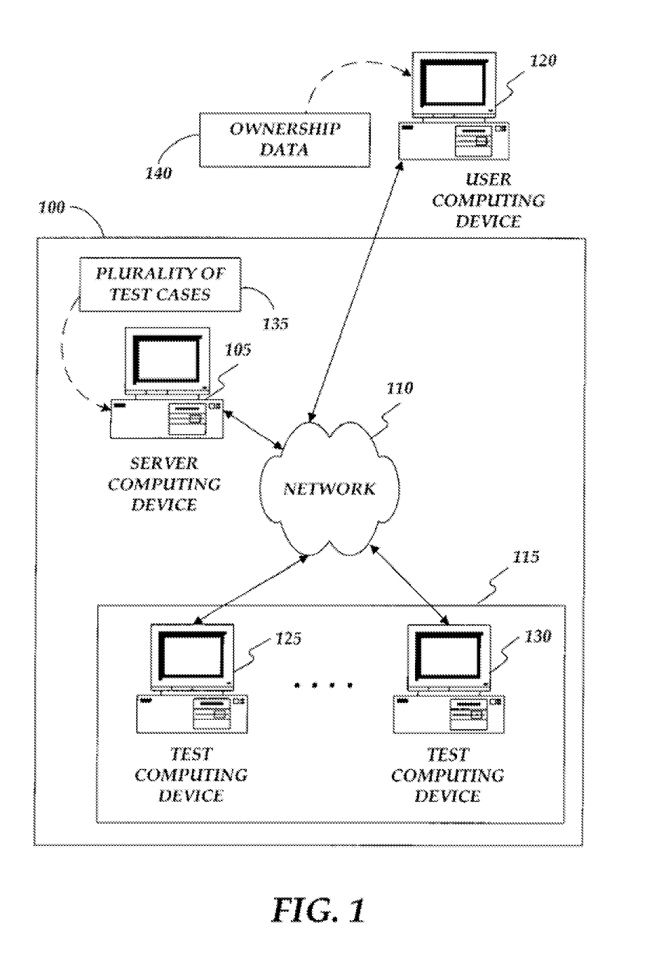

FIG. 1 is a block diagram of an automate testing system 100 consistent with embodiments of the invention. System 100 may include a server computing device 105, a network 110, and a plurality of test computing devices 115. Server computing device 105 may communicate with a user computing device 120 over network 110. Ownership data 140 may be sent to server computing device 106 from user computer device 120. Plurality of test computing devices 115 may include, but is not limited to, test computing devices 125 and 130, in addition, plurality of test computing devices 115 may comprise a plurality of test computing devices in, for example, a test laboratory controlled by server computing device 105. Plurality of test computing devices 115 may each have different microprocessor models and/or different processing speeds. Furthermore, plurality of test computing devices 115 may each have different operating systems and hardware components.

Code coverage data may be collected using system 100. System 100 may perform a run or series of runs. A run may comprise executing one or more test eases (e.g. a plurality of test cases 135) targeting a single configuration. A configuration may comprise the state of the plurality of test computing devices 115 including hardware, architecture, locale, and operating system. System 100 may collect code coverage data (e.g. traces) resulting from running the test cases. As described above, and as described in more detail below, each trace may be tagged with ownership data and saved In a trace database 303.

Network 110 may comprise, for example, a local area network (LAN) or a wide area network (WAN). Such networking environments are commonplace in offices, enterprise-wide computer networks, intranets, and the internet. When a LAN is used as network 110, a network interface located at any of the computing devices may be used to interconnect any of the computing devices. When network 110 is implemented in a WAN networking environment, such as the Internet, the computing devices may typically include an internal or external modem (not shown) or other means for establishing communications over the WAN. Further, in utilizing network 110, data sent over network 110 may he encrypted to insure data security by using encryption/decryption techniques.

In addition to utilizing a wire line communications system as network 110, a wireless communications system, or a combination of wire line and wireless may be utilized as network 110 in order to, for example, exchange web pages via the Internet, exchange e-mails via the Internet, or for utilizing other communications channels. Wireless can be defined as radio transmission via the airwaves. However, it may be appreciated that various other communication techniques, can be used to provide wireless transmission, including infrared line of sight, cellular, microwave, satellite, packet radio, and spread spectrum radio. The computing devices in the wireless environment can he any mobile terminal, such as the mobile terminals described above. Wireless data may include, but is not limited to, paging, text messaging, e-mail, Internet access and other specialized data applications specifically excluding or Including voice transmission. For example, the computing devices may communicate across a wireless interface such as, for example, a cellular Interface (e.g., general packet radio system (GPRS), enhanced data rates for global evolution (EDGE), global system for mobile communications (GSM)), a wireless local area network interface (e.g., WLAN, IEEE 802), a bluetooth interface, another RF communication interface, and/or an optical Interface.

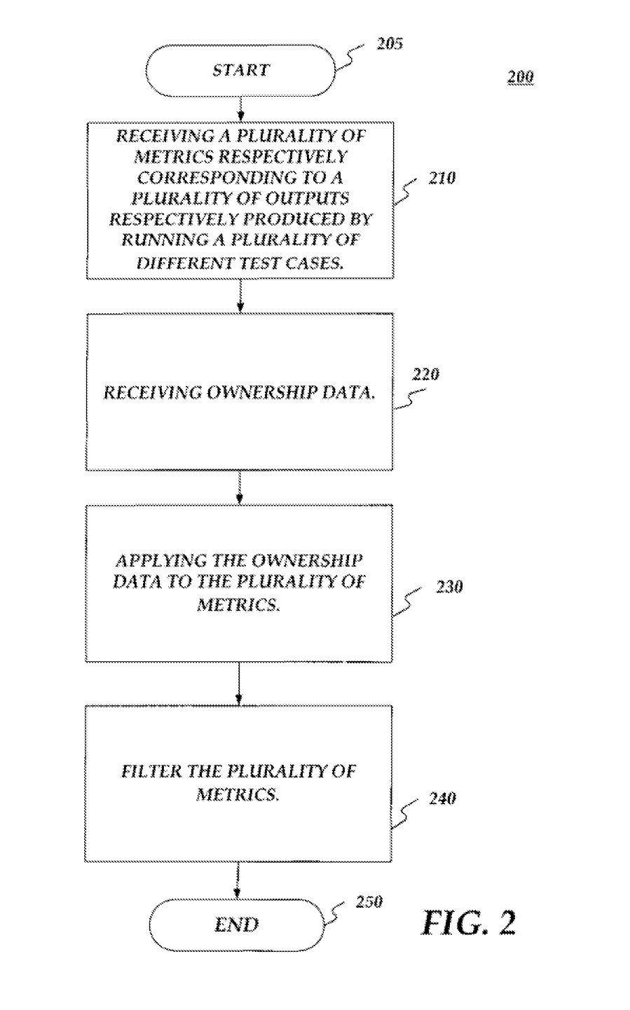

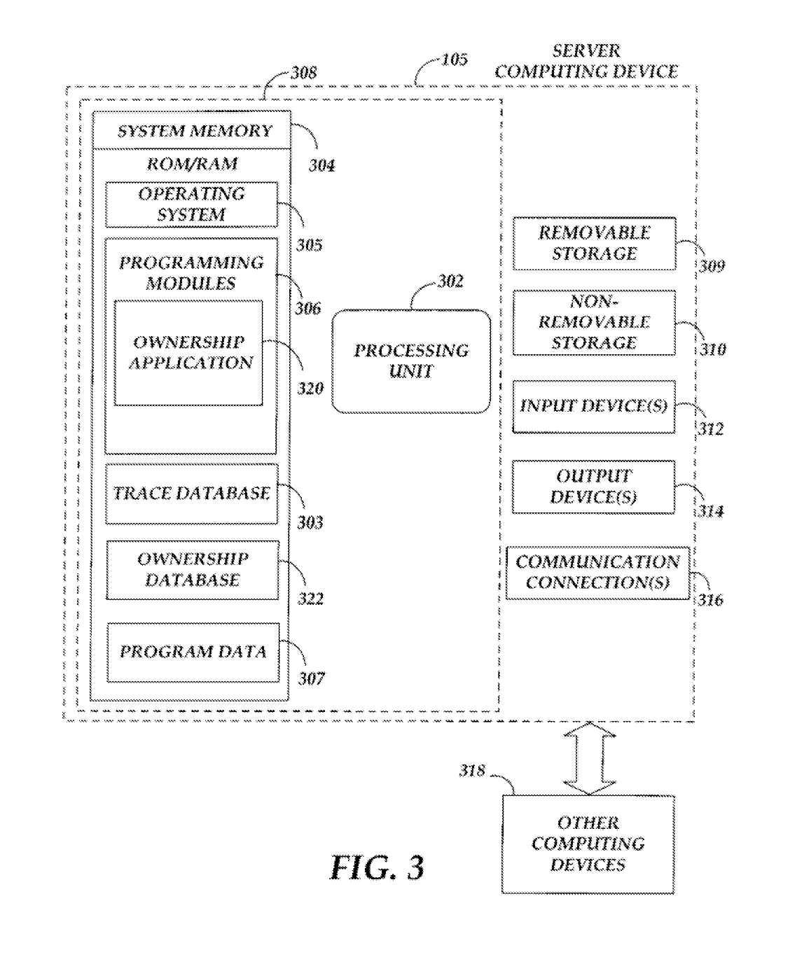

FIG. 2 is a flow chart setting forth, the general stages involved in a method 200 consistent with embodiments of the invention for providing ownership. Method 200 may be implemented using a computing device 105 as described in more detail below with respect to FIG. 3. Ways to implement method 200's stages will be described in greater detail below. Method 200 may begin at starting block 205 and proceed to stage 210 where computing device 105 may receive, in response to running plurality of different test cases 135, a plurality of traces. Each of the plurality of traces may respectively correspond to a plurality of outputs respectively produced by cunning each of plurality of different test cases 135. For example, a software developer may wish to test the software program. When developing software, software programs may be tested during the development process. Such testing may produce code coverage data. Code coverage data may comprise metrics that may indicate what code pieces (e.g. code fines) within a tested programming module have been executed during the software program's test.

Each one of plurality of different test cases 135 may be configured to test a different aspect of the software program. To test the software program, plurality of different test cases 135 may operate on a binary executable version of the software program populated with coverage code. For example, one of plurality of test cases 135 may be configured to cause the binary executable version to open a file, white another one of plurality of test cases 135 may cause the binary executable version to perform another operation. Consequently, the coverage code in the binary executable version may be configured to produce code coverage data configured to indicate what code within the binary executable version was used during the test, in this test example, the coverage code may produce the code coverage data indicating what code within the binary executable version was executed during the file opening test.

Plurality of test computing devices 115 may comprise a plurality of test computing devices in, for example, a test laboratory controlled by server computing device 105. To run plurality of test casts 135, server computing device 105 may transmit, over network 110, plurality of test cases 135 to plurality of test computing devices 115. Server computing device 105 may oversee running plurality of test cases 135 on plurality of test computing devices 115 over network 110. Before running plurality of test cases 135, plurality of test computing devices 115 may be setup in a single configuration. A configuration may comprise the state of the plurality of test computing devices 115 including hardware, architecture, locale, and operating system. Locale may comprise a language in which the software program is to user interface. For example, plurality of test computing devices 115 may be setup in a configuration to test a word processing software program that is configured to interface with users in Arabic. Arabic is an example and any language may be used.

As stated above, computing device 105 may receive, in response to running plurality of test cases 135, a plurality of tracts. Each of the plurality of traces may respectively correspond to a plurality of outputs respectively produced by each of plurality of test cases 135. For example, a trace may comprise a unit of code coverage data collected from a test case run. A trace may comprise a representation of code blocks executed from the beginning to the end of the test case. For example, the tester may collect one trace for each test case run. In the above file opening example, the trace returned from such a test case may indicate all lines of code in the software program that were executed by the software program by the file open test case.

Plurality of test cases 135 running on plurality of test computing devices 115 may respectively produce the plurality of traces. For example, a first line of code corresponding to the software program may be executed by a first test case within plurality of different test cases 136 and the same first line of code may be executed by a second test case within plurality of different test cases 135. Corresponding traces produced by the first and second test cases may indicate that both test cases covered the same code line. Once plurality of test computing devices 115 produce the plurality of traces, plurality of test computing devices 115 may transmit the plurality of traces to computing device 105 over network 110. Server computing device 105 may save the plurality of traces in trace database 303 as described in more detail below with respect to FIG. 3.

From stage 210, where computing device 105 receives the plurality of traces, method 200 may advance to stage 220 where computing device 105 may receive ownership data 140. For example, received ownership data 140 may indicate at least one testing entity responsible for fasting at least one function corresponding to the software program that was tested as a result of running plurality of different test cases 135. The at least one testing entity may comprise a person responsible for testing the software program or a group of people responsible for testing the software program. The at least one function may correspond to a logical block of computer code corresponding to the software program.

A website, for example, may be used by server computing device 105 to receive ownership data 140. The website may give individual testers the ability to browse source files and functions in a database corresponding to the software program. While browsing, the testers can claim ownership for particular source files and functions. Moreover, testers may also view the source files and functions already owned by other testers. For example, testers may select functions or source files by clicking a checkbox by each item and clicking a button to submit the ownership changes. This tasting entity ownership data 140 collated by the website may be saved in an ownership database 322 as described in more detail below with respect to FIG. 3.

Furthermore, received ownership data 140 may indicate at least one developing entity responsible for developing computer code corresponding to at least one function corresponding to the software program that was tested as a result of running plurality of different test cases 135. The at least one developing entity may comprise a person responsible for developing the software program or a group of people responsible for developing the software program. As stated above, the at least one function corresponds to a logical block of computer code corresponding to the software program.

Consistent with embodiments of the invention, a database may be populated with static data corresponding to the software program. This static data may include, but Is not limited to, source fits and functions that are complied to make the software program. Various parsers, for example, may strip information from this database regarding entities who developed the source files and functions associated with the software program. For example, names corresponding to individuals who wrote or developed the software program may appear in comment lines within the source file. Furthermore, names corresponding to individuals who wrote or developed Individual functions within the software program may appear in comments lines within the source file above the corresponding functions. The aforementioned parsers may be configured to strip this developing entity ownership information from the source file. Like the testing entity ownership data, this developing entity ownership data may be saved in ownership database 322.

Once computing device 105 receives the ownership data in stage 220, method 200 may continue to stage 230 where computing device 105 may apply the ownership data 140 to metrics corresponding to the plurality of traces. For example, a function corresponding to the software program for which a first trace in plurality of traces 135 contains test data may be used. The first trace may be obtained from trace database 322. From ownership database 322, a testing entity responsible for testing the function may be determined. Similarly, from ownership database 322, a developing entity responsible for developing the function may also be determined. Next, an ownership tag Indicating the determined testing entity may be applied to the code that the first trace touched. Similarly, the ownership tag may also indicate the determined developing entity. For example, in a metrics database, a representation of each function that may make up the software program may be stored. With each function, there may exist a set of metrics that comprise information about that function (e.g. how well is it exercised during testing and how much has the function changed since die last time data was collected.) Ownership may be applied to this metrics database, which allows, for example, a compiled set of metrics for all functions owned by a particular fester.

In other words, once ownership data is determined, it can be applied to any number of data sources. This ownership data could be used while generating stale reports, or it could be Injected into a database for creating more dynamic reports. For example, a database may represent each function in the software program. Custom tables may be generated in this database and populated with ownership data maintained in ownership database 322. With the ownership information populated, meaningful reports can be generated for individuals, including, for example, the following: i) overall code coverage of code owned by an individual; ii) a listing of functions (and their related metrics) owned by the individual; and iii) a listing of functions that may need more attention (e.g. low code coverage). Using a database that tracks people in the entrance, individuals can be mapped to the team they belong to and provide similar views at the team level.

After computing device 105 applies ownership data 140 in stage 230, method 200 may proceed to stage 240 where computing device 105 may filter the metrics associated, for example, with the plurality of traces. For example, ownership data indicating a testing entity responsible for testing the software program may be received. A user may wish to see which metrics corresponding to traces in trace database 303 correspond to & particular testing entity having responsibility for testing a particular function in the software program. Consequently, the user using user computing device 120 may transmit ownership data 140 to server computing device 105. Next, metrics corresponding to at least a first trace within the plurality of traces having an ownership tag corresponding to ownership data 140 may be determined. For example, based on received ownership data 140, server computing device 105 may query trace database 303 for the first trace based on received ownership data 140. Next, the determined metrics corresponding to the first trace may be transmitted back to the user at user computing device 120 over network 110. Once computing device 105 filters the plurality of metrics corresponding to the plurality of traces in stage 240, method 200 may then end at stage 250.

An embodiment consistent with the invention may comprise a system for providing ownership. The system may comprise a memory storage and a processing unit coupled to the memory storage. The processing unit may be operative to receive, in response to running a plurality of different test cases, a plurality of traces. Each of the plurality of traces may respectively correspond to a plurality of outputs respectively produced by running each of the plurality of different test cases, in addition, the processing unit may be operative to receive ownership data and to apply the ownership data to the plurality of traces.

Another embodiment consistent with the invention may comprise a system for providing ownership. The system may comprise a memory storage and a processing unit coupled to the memory storage. The processing unit may be operative to receive ownership data indicating a testing entity responsible for testing a software program. In addition, the processing unit may be operative to apply the ownership data, to a plurality of traces and to filter the plurality of traces. The processing unit being operative to filter the plurality of traces may comprise the processing unit being operative to determine at least a first trace within the plurality of traces having an ownership tag corresponding to the ownership data and to transmit the determined first trace.

Yet another embodiment consistent with the invention may comprise a system for providing ownership. The system may comprise a memory storage and a processing unit coupled to the memory storage. The processing unit may be operative to receive, in response to running a plurality of different test cases, a plurality of traces. Each of the plurality of traces may respectively correspond to a plurality of outputs respectively produced by running each of the plurality of different test cases. In addition, the processing unit may be operative to receive ownership data indicating at least one of the following: a testing entity responsible for testing a software program and a developing entity responsible for developing the software program. Moreover, the processing unit may be operative to apply the ownership data to the plurality of traces and to filter the plurality of traces based on the applied ownership data.

FIG. 3 is a block diagram of a system Including computing device 105. Consistent with an embodiment of the invention, the aforementioned memory storage and processing unit may be implemented in a computing device, such as computing device 105 of FIG. 3. Any suitable combination of hardware, software, or firmware may be used to implement the memory storage and processing unit. For example, the memory storage and processing unit may be implemented with computing device 105 or my of other computing devices 318, in combination with computing device 105. The aforementioned system, device, and processors are examples and other systems, devices, and processors may comprise the aforementioned memory storage and processing unit, consistent with embodiments of the invention. Furthermore, computing device 105 may comprise an operating environment for system 100 as described above. System 100 may operate in other environments and is not limited to computing device 105.

With reference to FIG. 3, a system consistent with an embodiment of the invention may include a computing device, such as computing device 105. In a basic configuration, computing device 105 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or mom programming modules 306, and may include a program data 307. System memory 304 may also include trace database 303 and ownership database 322 in which server computing device 105 may respectively save the plurality of traces and the ownership data. Operating system 305, for example, may be suitable for controlling computing device 105's operation. In one embodiment, programming modules 306 may Include, for example ownership application 320. Furthermore, embodiments of the Invention may be practiced in conjunction with a graphics library, other operating systems, or any other application program and is not limited to any particular application or system. This basic configuration is illustrated in FIG. 3 by those components within a dashed line 308.

Computing device 105 may have additional features or functionality. For example, computing device 105 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or ether data. System memory 304, removable storage 309, and non-removable storage 310 are all computer storage media examples (i.e. memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information end which can be accessed by computing device 105. Any such computer storage media may he part of device 105. Computing device 105 may also have input device(s) 312 such as a keyboard, a mouse, a pen, a sound input device, a touch input device, etc. Output device(s) 314 such as a display, speakers, a printer, etc, may also be included. The aforementioned devices are examples and others may be used.

Computing device 105 may also contain a communication connection 316 that may allow device 106 to communicate with other computing devices 318, such as over a network (e.g. network 110) in a distributed computing environment, for example, an intranet or the Internet. As described above, other computing devices 318 may include plurality of test computing devices 115 and user computer device 120. Communication connection 316 is one example of communication media. Communication media may typically be embodied by computer readable Instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wined network or direct-wired connection, and wireless media such as acoustic, radio frequency (RF), infrared, and other wireless media. The term computer readable media as used herein may include both storage media and communication media.

As stated above, a number of program modules and data files may be stored in system memory 304, including operating system 305. While executing on processing unit 302, programming modules 306 (e.g. ownership application 320) may perform processes including, for example, one or more method 200's stages as described above. The aforementioned process Is m example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the Invention may be practiced in an electrical circuit comprising discrete electronic elements, packaged or integrated electronic chips containing logic gates, a circuit utilizing a microprocessor, or on a single chip containing electronic elements or microprocessors. Embodiments of the inversion may also be practiced using other technologies capable of performing logical operations such as., for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of Instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CO-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested In and the property of the Applicant. The Applicant retains and reserves ail rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing ownership, the method comprising:
receiving, in response to running a plurality of different test cases, a plurality of traces, each of the plurality of traces respectively corresponding to a plurality of outputs respectively produced by running each of the plurality of different test cases;
receiving ownership data; and
applying the ownership data to metrics corresponding to the plurality of traces.

2. The method of claim 1, wherein receiving the plurality of traces comprises receiving the plurality of traces wherein the plurality of traces each respectively indicates code lines, corresponding to a software program, that were executed as a result of running the plurality of different test cases.

3. The method of claim 1, wherein receiving the plurality of traces comprises receiving the plurality of traces wherein the plurality of traces each respectively indicates code lines, corresponding to a software program, that were executed as a result of running the plurality of different test cases wherein a first line of code corresponding to the software program was executed by a first test case within the plurality of different test cases and the first line of code corresponding to the software program was executed by a second test case within the plurality of different test cases.

4. The method of claim 1, wherein receiving the ownership data comprises receiving the ownership data indicating at least one testing entity responsible for testing at least one function corresponding to a software program that was tested as a result of running the plurality of different test cases.

5. The method of claim 4, wherein receiving the ownership data indicating the at least one testing entity comprises receiving the ownership data indicating the at least one testing entity comprising one of the following: a person responsible for testing the software program and a group of people responsible for testing the software program.

6. The method of claim 1, wherein receiving the ownership data comprises receiving the ownership data indicating at least one testing entity responsible for testing at least one function corresponding to a software program that was tested as a result of running the plurality of different test cases wherein the at least one function corresponds to a logical block of computer code corresponding to the software program.

7. The method of claim 1, wherein receiving the ownership data comprises receiving the ownership data indicating at least one developing entity responsible for developing computer code corresponding to at least one function corresponding to a software program that was tested as a result of running the plurality of different test cases.

8. The method of claim 7, wherein receives the ownership data indicating the at least one developing entity comprises receiving the ownership data indicating the at least one developing entity comprising one of the following: a person responsible for developing the software program and a group of people responsible for developing the software program.

9. The method of claim 1, wherein receiving the ownership data comprises receiving the ownership data Indicating at least one developing entity responsible for developing computer code corresponding to at least one function corresponding to a software program that was tested as a result of funning the plurality of different test cases wherein the at least one function corresponds to a logical block of computer code corresponding to the software program.

10. The method of claim 1, wherein applying the ownership data to the metrics corresponding to the plurality of traces comprises applying the ownership data to the metrics corresponding to the plurality of traces comprising:
determining a function corresponding to a software program for which a first trace of the plurality of traces contains test data;
determining a testing entity responsible for testing the function;
applying, to metrics corresponding to the first trace, an ownership tag indicating the testing entity.

11. The method of claim 1, wherein applying the ownership data to the metrics corresponding to the plurality of traces comprises applying the ownership data to the metrics corresponding to the plurality of traces comprising:
determining a function corresponding to a software program for which a first trace of the plurality of traces contains test data;
determining a developing entity responsible for developing the function;
applying, to the metrics corresponding to the first trace, an ownership tag indicating the developing entity.

12. The method of claim 1, further comprising running the plurality of different test cases.

13. The method of claim 12, wherein running the plurality of different test cases comprises running the plurality of different test oases wherein each of the plurality of different test cases Is respectively configured to test a different aspect of a software program.

14. The method of claim 1, further comprising filtering the plurality of traces comprising:
receiving ownership data indicating a testing entity responsible for testing a software program,
determining metrics corresponding to at least a first trace within the plurality of traces having an ownership tag corresponding to the ownership data; and
transmitting the determined metrics.

15. A computer-readable medium which stores a set of instructions which when executed performs a method for providing ownership, the method executed by the set of instructions comprising:
receiving ownership data indicating a testing entity responsible for testing a software program:
applying the ownership data to metrics corresponding to a plurality of traces; and
filtering the metrics corresponding to the plurality of traces wherein filtering the metrics corresponding to the plurality of traces comprises:
determining metrics corresponding to at least a first trace within the plurality of traces having an ownership tag corresponding to the ownership data, and
transmitting the determined metrics corresponding to the first trace.

16. The computer-readable medium of claim 15, wherein receiving the ownership data comprises receiving the ownership data indicating at least one testing entity responsible for testing at least one function corresponding to a software program that was tested as a result of running a plurality of different test cases respectively corresponding to the plurality of traces.

17. The computer-readable medium of claim 16, wherein receiving the ownership data indicating the at least one testing entity comprises receiving the ownership data indicating the at least one testing entity comprising one of the following: a person responsible for testing the software program and a group of people responsible for testing the software program.

18. The computer-readable medium of claim 15, wherein receiving the ownership data comprises receiving the ownership data indicating at least one losing entity responsible for testing at least one function corresponding to a software program that was tested as a result of running a plurality of different test cases respectively corresponding to the plurality of traces wherein the at least one function corresponds to a logical block of computer code corresponding to the software program.

19. The computer-readable medium of claim 15, wherein applying the ownership data to the metrics corresponding to the plurality of traces comprises applying the ownership data to the metrics corresponding to the plurality of traces comprising:
determining a function corresponding to a software program for which a first trace of the plurality of traces contains test data;
determining a testing entity responsible for testing the function;
applying, to metrics corresponding to the first trace, an ownership tag indicating the testing entity.

20. A system for providing ownership, the system comprising;
a memory storage; and
a processing unit coupled to the memory storage, wherein the processing unit is operative to:
receive, in response to running a plurality of different test eases, metrics corresponding to a plurality of traces, each of the metrics corresponding to the plurality of traces respectively corresponding to a plurality of outputs respectively produced by running each of the plurality of different test cases;
receive ownership data indicating at feast one of the following: a testing entity responsible for testing a software program: and a developing entry responsible for developing, the software program;
apply the ownership data to the metrics corresponding to the plurality of traces; and
filter the metrics corresponding to the plurality of traces based on the applied ownership data.
